(19) United States
(12) Patent Application Publication
(10) Pub. No.: US 2024/0367379 A1
(43) Pub. Date: Nov. 7, 2024

(54) CUSTOMIZABLE 3D PRINTED MICROPLATE FOR HIGH-THROUGHPUT LASER SPECTROSCOPY

(71) Applicant: Salvo Technologies, Inc., Largo, FL (US)

(72) Inventors: Lenzi Williams, Clearwater, FL (US); Abdeljabbar R. Khamis, Cutler Bay, FL (US); Daniel Schwerin, Seminole, FL (US)

(21) Appl. No.: 18/143,739

(22) Filed: May 5, 2023

Related U.S. Application Data
(60) Provisional application No. 63/339,603, filed on May 9, 2022.

(51) Int. Cl. B29C 64/386; B33Y 10/00; B33Y 50/00; B33Y 80/00; G01N 21/01

(52) U.S. Cl. CPC B29C 64/386; B33Y 10/00; B33Y 50/00; B33Y 80/00; G01N 21/01

(57) ABSTRACT

In the field of laser spectroscopy, a method for making customizable three-dimensional printed microplates using customizable additive and subtractive manufacturing such as 3D printed microplates for high-throughput laser spectroscopy is disclosed.

### CROSS-REFERENCE TO RELATED APPLICATION

The present application claims the benefit of previously filed co-pending Provisional Patent Application, Ser. No. 63/339,603 filed on May 9, 2022.

### FIELD OF THE INVENTION

The method of this disclosure belongs to the field of laser spectroscopy. More specifically it is the use customizable microplates using additive and subtractive manufacturing for high-throughput laser spectroscopy.

### BACKGROUND OF THE INVENTION

The industrial and technological revolution has allowed the creation and innovation of tools that facilitate the daily activities of society. In this aspect, the exponential technological increase of the last century has developed instruments aimed at the scientific field. One of the inventions that impacted the biomedical field was the creation of microplates, which is a set of multi-well plates used for biological, pharmaceutical, and biomedical analyses. This instrument was designed by the Hungarian microbiologist Dr. Gyula Takatsy, and its main purpose was to test blood lots for an influenza epidemic that was raging in that country in the early 1950's. It is important to note that the microplate has not been an exception to the aforementioned technological advance, since with short time to be innovated, it has helped to achieve great advances in the biotechnological field.

Today, microplates are widely used in all analytical research facilities and clinical diagnostic testing laboratories for the general handling of substances under analysis. In other words, they are used to contain, transfer, and microscopically analyze substances. It should be noted that although the microplate has undergone a series of innovations over the years, it has never lost its basic concept given by Dr. Gyula Takatsy.

Furthermore, microplates created through the use of additive and subtractive manufacturing such as 3D printing technology have been one of the highest points of innovation that this industry has presented. This technology enables the rapid, efficient, and inexpensive fabrication of microplates with physical properties similar to those created by routine procedures. Basically, this 3D printing consists of manufacturing a microplate from a three-dimensional digital model, generally adding a biocompatible material layer by layer. It is important to highlight that the biocompatibility of the manufacturing materials nullifies any possible negative effect on the analyses, that is, it avoids contamination of the analyte and therefore a drastic reduction in the percentages of failures intrinsically induced by the material. In the biological environment, the selection of the appropriate manufacturing material minimizes the possible effects of leaching or degradation of the cells under study.

### BRIEF SUMMARY OF THE INVENTION

The method of this invention uses customizable additive and subtractive manufacturing such as 3D printed microplates for high-throughput laser spectroscopy.

### BRIEF DESCRIPTION OF THE DRAWINGS

For a fuller understanding of the nature and objects of the invention, reference should be made to the following detailed description, taken in connection with the accompanying drawings, in which:

FIG. 1 shows the preferred embodiment 3D microplate fabrication process of this disclosure;

FIG. 2 shows a picture of the preferred embodiment 96-well Microplate of this disclosure;

FIGS. 3a, 3b, and 3c show charts of how the preferred embodiment Microplate of this disclosure meets certain chemical, mechanical and physical requirements; and,

FIG. 4 shows the preferred embodiment leak test process.

### DESCRIPTION OF THE PREFERRED EMBODIMENT

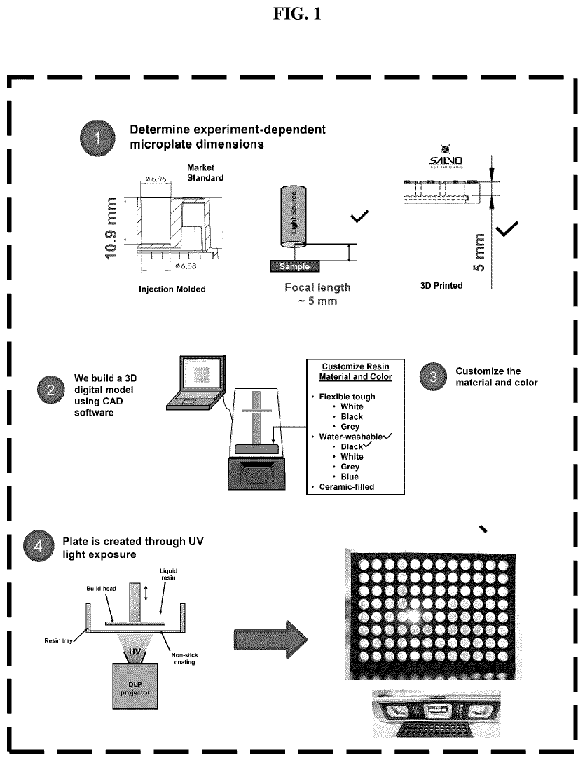

As shown in the figures microplates produced by 3D printing generally have 6 phases for their manufacture. The first 4 phases are shown in FIG. 1. First, the dimensions of the microplate are selected (1), which is related to the number of wells it will have. The most useful microplate on the market is the 96-well microplate, although there are more than 8 microplates of different sizes, that is, all with different numbers of wells. The proper selection for microplate fabrication is directly tied to the amount of analyte volume to be handled or studied. For example, the 96-well plate is typically capable of handling between 320 to 360 microliters per well of a substance, while a 1536-well plate is typically capable of carrying 10.7 to 12.8 microliters. Second, a three-dimensional digital model is built using design programs such as SolidWorks or Autodesk's Fusion360 (2), which will be translated into an optimal language for 3D printing. The designer of this model has the ability to adjust and/or modify the standard dimensions and innovate or customize the final product to adjust it to the needs of the study to be carried out. It is important to note that not only can the dimensions be modified in this model, but also the creation of assembly parts can be designed to improve analysis handling.

Next, selection of a suitable surface is then made based on the adhesion and biochemical requirements of the test (3). For example, if the study is looking at cellular agents, then the nature of the cell attachment, the type of anchorage, and the dependent cell growth rate are factors that must be crucially considered when selecting the microplate surface. In other words, the factors mentioned above must be analyzed in detail as they determine the detection methods to be applied in the study. There are several detection methods that are frequently used in industries, among the most used are colorimetric, luminometric and fluorometric analyses, which are used for absorbance, luminescence, and fluorescence testing, respectively. Depending on the method to be used, the color of the microplate is selected. For example, if the method used for the experiments is fluorometric analysis, black color is selected since it reduces light scattering and results in a higher signal-to-noise ratio, therefore better and more accurate experimental results. On the other hand, if luminometric analysis is used, the microplate should have a white color, as this improves the luminescence signal-to-noise ratio by reflecting light back to the detector. In a nutshell, color variation in microplate fabrication is done to optimize analytical studies. Once the dimensions, surface, detection method and color of the microplate are determined, a biocompatible material is chosen (4), that is, a material that greatly reduces the fatal contamination of the analyte.

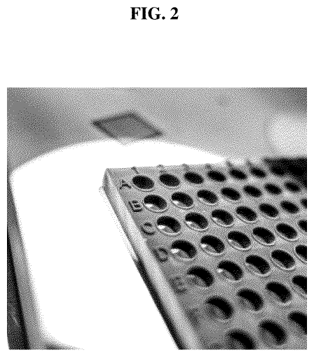

Finished customized microplates as shown in FIG. 2, depending on their use in the scientific field, must meet certain chemical, mechanical and physical requirements. In other words, the surface characteristics, the properties of the creation material and its cytotoxicity must be evaluated in detail and adapted to the microplate requirement and field of study. In the biological field, specifically in cellular investigations, surface characteristics such as wettability and surface topography play an important role as they ensure an optimal environment for cellular agents. For example, the internal and external design of the microplate can be adjusted for data collection using the surface-enhanced Raman spectroscopy (SERS) detection method, that is, the universal idea of a 96-well microplate was maintained, but the well dimensions were adapted to the aforementioned technique.

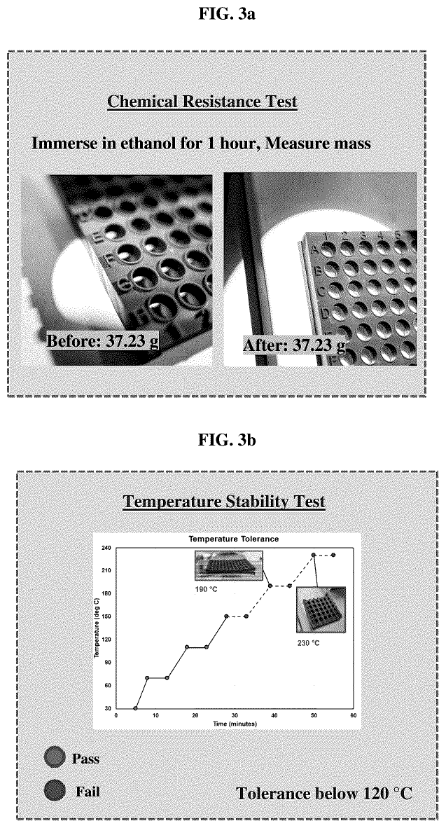

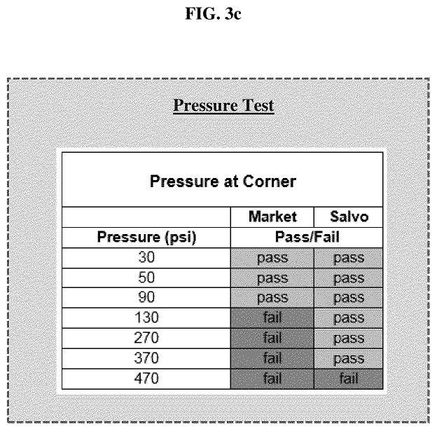

It should be noted that the preferred embodiment microplate was subjected to chemical, physical, and mechanical stability tests. As shown in FIG. 3a, first the microplate was subjected to chemical resistance tests, that is, it was immersed in two types of chemical solvents for one hour at room temperature. Ethanol and isopropanol were the chemical solvents selected because their common use in the industrial disinfection task. It is important to note that before and after submitting the microplate to the chemical stability test, it was dried at a temperature of 80 Celsius for one hour to remove any remaining liquid particle and thus be able to obtain a high percentage of precision at the weighing time. The microplate was weighed to corroborate the law of conservation of mass and to be able to affirm that the selected material does not undergo deformations with the aforementioned chemical solvents. Likewise, it was observed that the applied chemicals, in addition to providing a disinfected environment, also morphologically modify the roughness of the microplate by smoothing the surface.

Moreover, since sterilization processes that include high temperatures are used industrially, it was decided to subject the microplate to temperatures of up to 230 Celsius to analyze the useful life of its material. Of note, significant changes in the microplate structures were observed when the temperature exceeded 120 Celsius, in other words, as shown in FIG. 3b, the microplate can be safely exposed to any temperature range below 120 Celsius without experiencing any potential damage. Finally, the microplate was subjected to various hydraulic pressures to determine how much mechanical stress it could withstand. The pressures were distributed in 3 structural parts of the microplate. As shown in FIG. 3c, it is important to note that the highest pressure the microplate withstood was 670 psi, certainly a considerably high pressure.

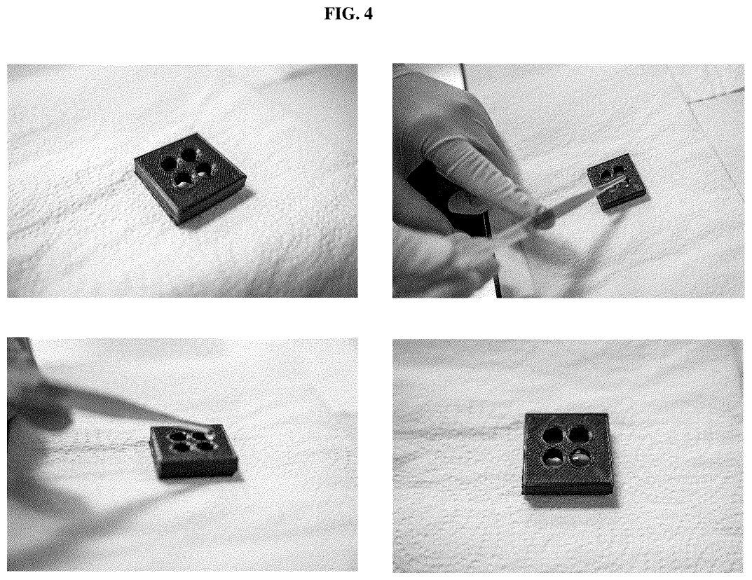

Once the microplate was completely fabricated, possible materials and techniques to seal the bottom were investigated. It should be noted that the selected material must provide an adequate environment for the analyte under study and at the same time provide stability and support to the microplate structure, for this reason glass was the chosen material. The technique implemented to fuse the aforementioned elements is based on a material extrusion strategy (5), which consists of embedding the glass slide into the microplate while the 3D printing is running. In this study, this material extrusion strategy phase (5) was interconnected with the use of a multipurpose silicone adhesive (6), which was executed to avoid potential leaks and contamination. Furthermore, methylene blue was the molecule used to perform the leaking tests, which were conducted by depositing the dye in certain microplate wells for more than 48 hours as shown in the photographs FIG. 4 starting in the upper left corner and rotating clockwise. It is important to highlight that a total seal was achieved based on the non-transfer of the dye between the microplate wells.

Since certain changes may be made in the above-described method of using customizable additive and subtractive manufacturing such as 3D printed microplates to build a microplate where the designer has the ability to adjust and/or modify the standard dimensions and innovate or customize the final product to adjust it to the needs of the study to be conducted without departing from the scope of the invention herein involved, it is intended that all matter contained in the description thereof shall be interpreted as illustrative and not in a limiting sense.

What is claimed is:

1. A method for making customizable three-dimensional printed microplates comprising:
first, determining the dimensions of the microplate which determines the number of wells said microplate will have;
second, building a three-dimensional digital model using a design program;
next, selecting a suitable surface to be made based on the adhesion and biochemical requirements of the test to be performed;
then, choosing a biocompatible material that reduces the fatal contamination of the analyte; and,
then fabricating the microplate.
